(19) United States
(12) Patent Application Publication
(10) Pub. No.: US 2002/0152136 A1
(43) Pub. Date: Oct. 17, 2002

(54) Web-based interface for facilitating commerce between providers of goods or services and purchasers thereof

(76) Inventor: Robert C. Hill, St. Louis, MO (US)

Correspondence Address: THOMPSON COBURN, LLP, ONE FIRSTAR PLAZA, SUITE 3500, ST LOUIS, MO, 63101, US

(21) Appl. No.: 09/827,203

(22) Filed: Apr. 5, 2001

(51) Int. Cl. G06F 17/60

(52) U.S. Cl. 705/27; 707/3

(57) ABSTRACT

The present invention pertains to a website that provides a means for users to browse through a virtual billboard displaying graphical advertisements of various providers of goods and/or services. The website of the invention allows users to display and obtain information regarding those providers of particular interest in an organized and systematical manner, without linking to separate websites. Furthermore, the invention allows such providers of goods and/or services to maintain an Internet presence without maintaining their own website.

### BACKGROUND OF THE INVENTION

(1) Field of the Invention

This invention pertains to the field of web-based interfaces for effectuating commerce between providers of goods or services and purchasers thereof.

(2) Description of the Related Art

The Internet has become popular as a means for consumers to identify goods and service providers and to compare such providers in an effort to make educated buying decisions. There are essentially two types of prior art methods for locating businesses on the Internet: web-based search engines and website directories. Unlike the present invention, both prior art search methods operate on the principal of linking users from one website to another.

Web-based search engines interrogate the web by searching through known web page and website addresses to identify matches between specific keywords entered by the user and those contained in the content and/or meta tags of known web page and website addresses. Those web addresses containing some or all of the keywords matching the users search are then usually listed in a visual interface in an order corresponding to the percentage of the keywords matched or using some other weighted method known in the art. Typically some form of heading is displayed for each web address listed to provide the user with some idea as to the nature of the web page or website at the given address. Additionally, at least a portion of the heading of each of the web addresses listed is commonly hyperlinked to the corresponding web address such that a user can then click on the hyperlink to connect to the particular web page or website.

Search algorithms provided on the majority of widely used search engines typically allow the user to enter a single keyword to perform a very broad search or, alternatively, to enter a logical expression to carry out a more specific search. For example, a search of the term “car” would likely return links to millions of websites, most of which would likely be irrelevant to a user. On the other hand, a search using a highly specific logical expression, such as “antique AND ford AND automobile AND ‘for sale’ AND memphis”, might result in no matches at all. Consequently, the user must often be experienced at drafting effective search expressions to achieve his or her desired results. This disadvantage of using common search engines is further compounded by the fact that the majority of widely used search engines utilize unique search algorithms, resulting in different results between different search engines despite using identical search expressions.

Aside from the burden imposed by such search engines on users, the above-mentioned aspects of search engines also impose a burden on website owners. This is because website owners typically must register their websites with each search engine provider or otherwise make known their Universal Resource Locator (URL). Furthermore, meta tags and web page content must be skillfully designed to work well with any particular search algorithm in order for the website to be identified as a match and, preferably, to be listed high in the above-mentioned order of results displayed to users. Given the high number of search engines (in the hundreds), the rapid emergence and extinction of existing web-based search engines, and the fact that the search engine providers frequently change their search algorithms, it is often a prohibitively expensive and time consuming task for small businesses to effectively maintain and market their websites. Consequently, the websites of most small businesses fail to be displayed prominently in the lists of search results generated by the most popular search engines.

As an alternative to search engines, Internet directories overcome many of the problems associated with search algorithms by categorizing websites according to the type of business or other classification pertaining to each of the websites. Typically, directories further categorize websites into subcategories and often have interfaces that allow users to select a main category, subcategory, and so forth. For example, automobile dealer websites can be associated with a main category such as “automobile” and a subcategory such as “dealers” and users can often select such categories from a static list or pop-down menu. Once specific categories of a directory have been selected, a list of web page addresses are typically listed for those websites associated with the specific categories. The order in which the websites are listed can vary by such things as date, size, popularity, and so forth. Directory lists are similar to the lists generated by most search engines and at least a portion of the heading of each listed website is commonly hyperlinked to the corresponding URL of the website such that a user can then connect to the particular web page or website by clicking the hyperlink using his or her mouse. Because directories may return vast numbers of websites matching any specific selection of categories, many directory-like search methods also include keyword search algorithms similar to those used by search engines to further narrow search results.

Despite the advantage gained by omitting websites not associated with a particular category or sub category during a search using directory search methods, such directory search methods can be disadvantageous in that alternative websites of interest to the user may be inadvertently omitted. For example, a user interested in casual dining may inadvertently search through websites of only those businesses categorized as “restaurants” and subcategorized as “casual dining” while the website of a desirable local bar, which also serves food, may not be included in the search if categorized under another subcategory such as “Bar & Grill.”

In addition to the disadvantages associated with specific search methods as discussed above, prior art search methods also have other inherent disadvantages. One such disadvantage is that prior art search methods are designed to direct users to other websites and they require users to link to a listed website in order to get any qualitative information from the search. From a user's perspective, searching through various websites to find qualitative information can be extremely frustrating and is often ineffective. In general, every website is unique and, as a result, there is no uniform procedure for navigating any given website. Thus, for each website visited, a user must determine the organization of the site and then determine where pertinent information, if any, is likely to be found. This can be a very tedious and time-consuming exercise. Even more frustrating, the user often finds the majority of the websites searched to be irrelevant to his or her search. Unfortunately, there is often no way of determining that a particular website is irrelevant without devoting a significant amount of time to explore the website.

Another disadvantage to users of prior art search methods lies in the difficulty of using such methods to compare providers based on information displayed on separate websites. The majority of websites are comprised of numerous web pages that are linked together in an often confusing manner. As a user searches for information, he or she is often vectored from one web page to another within a website, creating a history-trail of those web pages viewed. Since the search results vanish once a user links to a listed website, it is not possible for the user to link from one of the listed websites of a search to another without backtracking through the history-trail to bring up the search results once again. Thus, making comparisons of information provided in different websites is difficult and often impractical. Furthermore, this is especially tedious for the majority of users that have slow Internet connections, due to the amount of time it takes to download previously unviewed web pages. Additionally, the download time for web pages is not likely to be significantly reduced in the future since web page designers take advantage of increases in download speed by creating increasingly more complex websites.

Yet another disadvantage of both search engine and directory search methods is that such search methods identify only those websites that have been determined by the search algorithm to strictly satisfy search criteria, excluding websites that may be similar or potentially interesting to the user. Search engine methods identify specific websites that satisfy the user's specific search criteria. Similarly, directory search methods identify links to websites that fall into predetermined categories. Thus, search results obtained by prior search methods depend on the design of the search criteria and/or the database organization, and often exclude information that the user would deem pertinent.

Yet another disadvantage associated with prior art search methods is the burden they impose on businesses desiring to maintain an Internet presence. Virtually every commercial website is unique and each must be designed, programmed, and maintained in a host computer with permanent Internet access. The process of developing and maintaining a custom website is expensive, requiring skilled computer specialists and consuming substantial time. Small businesses often find maintaining a website and keeping search engine registrations up to date to be cost prohibitive. Furthermore, the failure to maintain search engine and directory registrations can result in the failure of a website to even be listed in the results of a search, thereby making a website effectively worthless unless other media is used to advertise the website address.

Finally, yet another disadvantage of prior art search methods is that they often merely list some form of a heading linked to a website or web page URL. More often than not, the user is unable to determine the nature of a website from its heading alone and must explore each website in an effort to determine if there is any relevance therein. Although a desirable website may be listed in the results of a search, even high in the order, headings are often so unclear that users misinterpret them and fail to link to pertinent websites. Thus, there is simply no effective mechanism to attract a potentially interested consumer to one website in a list of thousands or even millions of web addresses.

### SUMMARY OF THE INVENTION

The website of the present invention overcomes the disadvantages associated with prior art search methods by providing a means for users to browse through a virtual billboard displaying the advertisements of various providers of goods and/or services. Using the invention, users can display and obtain information regarding those providers of particular interest in an organized and systematical manner, without linking to separate websites. Furthermore, the invention allows such providers of goods and/or services to maintain an Internet presence without maintaining their own website. Thus, the present invention provides advantages over prior art web-based search methods, both for users and providers of goods and/or services.

In general, the preferred embodiment of the website of the invention comprises a visual interface that displays a plurality of billboard advertisements for various providers of goods and/or services. By selecting a particular billboard advertisement using a mouse, a user can display information pertaining to the particular provider in a separate region of the visual interface. The information may include but is not limited to such things as a brief description of the goods or services provided, the address of the provider, a map, phone numbers, business hours, specials or coupons, and catalogues or menus. The user can select to view only a particular type of information and each type of information can be retrieved for each provider in substantially the same manner such that the user can quickly obtain the exact information he or she is searching for from each selected provider.

The website of the preferred embodiment also contains more or more search mechanisms for facilitating a search. A first search mechanism preferably allows the user to select a particular main category of interest and prevents the billboard advertisements of unrelated providers from being displayed in the visual interface. A second search mechanism preferably identifies providers matching particular search criteria and visually distinguishes the billboard advertisements of those providers from among other billboard advertisements being displayed. A third search mechanism preferably allows a user to visually distinguish the billboard advertisements of related providers by selecting a specific sponsor billboard associated therewith. It should be understood that that the terms “first”, “second”, and “third” as used herein to identify the search mechanisms is used merely for identification and is not meant to limit such search mechanisms to being necessarily present or to being used in any particular order.

The website of the preferred embodiment is also provided with a means for allowing the user to associate various providers with a “favorites” list to allow the user to search through the billboard advertisements of known providers that are of specific interest to the user. Preferably, the billboard advertisement of those providers included in the favorites list are visually distinguished from other billboard advertisements being displayed using such means as superimposing a red circle over a portion of the billboard advertisement. Thus when the user is performing a search, he or she can easily identify familiar favorite providers among others being displayed.

The unique feature of the preferred embodiment of the invention that visually distinguishes the billboard advertisements of those providers associated with a particular criteria from other billboard advertisements of providers that are simultaneously displayed allows users to identify those providers that the user is most likely interested in without obscuring other potential providers not specifically associated with the particular search criteria. In essence, this feature is analogous to “highlighting” in newspaper advertisements for comparison purposes.

Similar to the “highlighting” feature described above, the “favorites” feature of the preferred embodiment of the invention makes it easy for the users visual identify and distinguish providers of which the user is familiar, without obscuring other possible providers of interest. For added convenience, the user can choose to selectively display only those providers previously selected as favorites. This can be beneficial in such situations, for example, where the user merely wishes decide upon a familiar place to eat and merely wishes to be reminded of his or her options.

Yet another unique feature incorporated in the website of the preferred embodiment that is advantageous over prior art search methods involves associating various providers with certain consumer group categories, such as, for example, teens, boaters, bikers, or campers rather than merely categories based upon the type of goods or services provided. This aspect of the invention allows users to select a consumer category and to then browse through the billboard advertisements of providers that cater to the specific consumer category, without requiring the selection of a particular class or type of goods or services.

The invention summarized above provides many advantages over prior art search methods for users seeking to identify and compare various providers of goods and/or services, as well as for providers seeking to advertise their goods and services on the Internet. For the providers of goods and services, the invention eliminates the need of maintaining a custom website and, therefore, eliminates all of the associated costs and burdens on resources. The graphical nature of the invention also allows providers to display graphic billboard advertisements at the search level to attract consumers to seek further information, eliminating the problems associated with confusing headings. For the user, the invention allows rapid retrieval of desired information in an organized and systematic manner without taking valuable time to surf the Internet exploring different websites for particular information.

While the principle advantages and features of the present invention have been described above, a more complete and thorough understanding of the invention may be attained by referring to the drawing figures and the detailed description of the preferred embodiment, which follow.

### BRIEF DESCRIPTION OF THE DRAWING FIGURES

FIG. 1 is a schematic representation of a visual display interface of the present invention.

FIG. 2 is a flow-diagram of the preferred embodiment showing various options available to users as a search is being conducted.

### DETAILED DESCRIPTION OF THE INVENTION

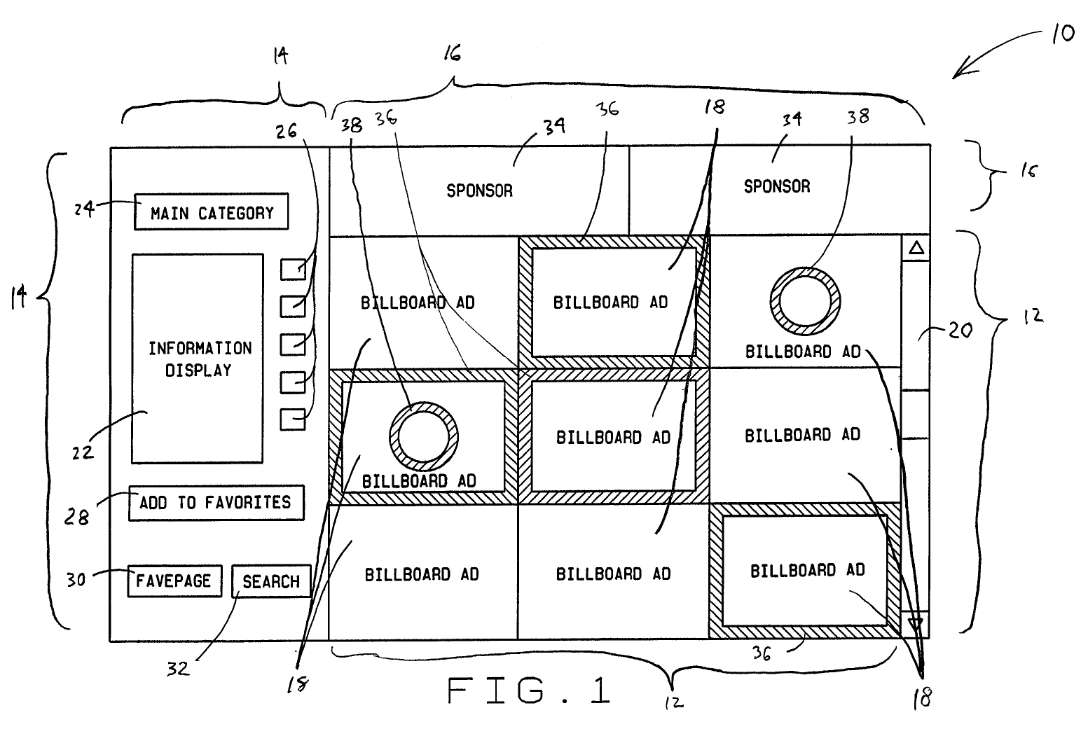

The preferred embodiment of the website of the invention comprises a plurality of web pages creating a visual interface 10 as shown schematically in FIG. 1. The visual interface is preferably contained within a single Internet browser window. However, it should be understood that the visual interface could be comprised of multiple open browser windows.

In general the visual interface 10 of the preferred embodiment preferably comprises first 12, second 14, and third 16 regions. While the various regions of the preferred embodiment are shown schematically as continuous regions having specific locations within a browser window, it should be understood that the regions could be discontinuous regions with the parts thereof being located anywhere within the visual interface 10.

The first region 12 of the visual interface 10 displays a plurality of symbols 18 representative of individual providers of goods and/or services. In the preferred embodiment, the symbols 18 are static graphical advertisements, hereinafter referred to as billboard ads, similar in appearance to banner advertisements commonly used on Internet websites as hyperlinks from one website to another. However, in alternative embodiments, the symbols 18 could be any form from text to animated graphical displays. If needed as discussed below, additional symbols 18 can be viewed by scrolling using a scrollbar 20, by paging-up/down, or by using other suitable means known in the art for this purpose. The second region 14 of the visual interface 10 of the preferred embodiment contains an information display portion 22 capable of showing information pertaining a provider whose corresponding symbol 18 has been selected as discussed below. The second region of the visual interface also preferably contains a main category selector 24, a plurality of information display selectors 26, an “add to favorites” selector 28, a “favorites page” selector 30, and a search selector 32. Finally, the third region 16 of the visual interface 10 preferably contains selectable sponsor advertisements 34.

The use and operation of the website is described below by its function rather than by describing the particular code or HTML format used to achieve the specific functions. It should be understood by persons skilled in the art having knowledge of the disclosure herein that the invention could be practiced using any method, format, or computer language and is not limited to any specific algorithm.

The preferred embodiment of the website of the invention is specifically configured to provide a means for users to identify and search through various local providers of goods or services. The website also provides a means for businesses to maintain an Internet presence without the disadvantages and costs associated with maintaining an individual website. Providers of goods or services, hereinafter “providers”, subscribe to the website and supply various categories of information, preferably along with a graphical symbol for their business. The information supplied by the providers may include such categories as address and contact information, directions, maps, special discount information, video advertisements, menus, catalogues, operating hours, pricing, and other commonly sought information used by consumers when making purchasing decisions. The graphical symbol of each provider is preferably a JPEG image of the business' trademark or some form of graphical advertisement. Subscribing providers may submit their respective graphical symbol and information for any of the above identified categories, via e-mail, floppy-disk, or any other method known in the art, to the persons or entity hosting the website. Like prior art search directories, each provider is also assigned to a particular main category based on the services or goods provided thereby. Additional subcategories may also be assigned. Both the main category and subcategories assigned to each providers may be chosen by the individual providers themselves or preferably by the website operators. All the above-mentioned information is preferably stored within the pages of the website and the providers need not maintain a connection therewith nor otherwise maintain an Internet presence. It should be understood that, over time, providers can be added or removed as needed and automated procedures may facilitate such changes.

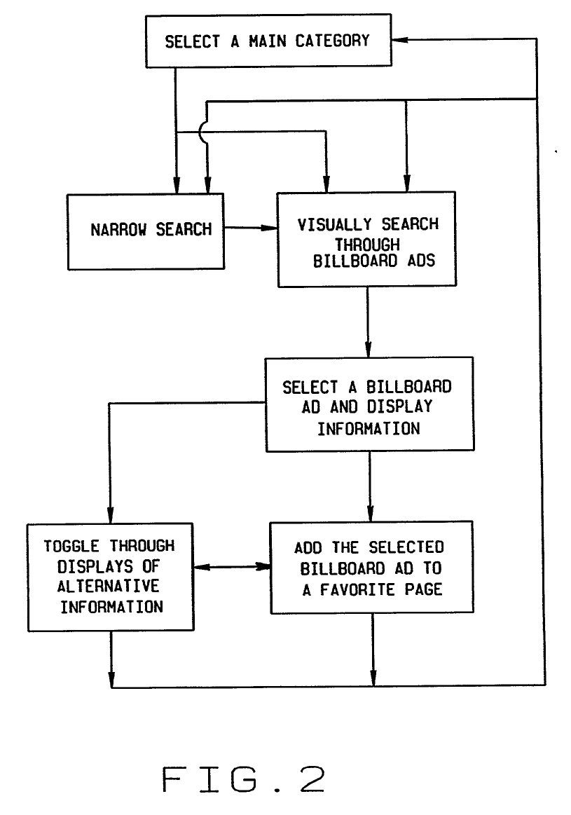

An on-line user desiring to compare or obtain information pertaining to providers of goods or services can then log onto the website which preferably maintains the visual interface 10 shown in FIG. 1. A flowchart of the use of the preferred embodiment of the website of the invention is shown generally in FIG. 2.

Although not required, a user desiring information regarding a particular category of goods or service providers can use the main category selector 24 of the visual interface 10 to select a main category from among all previously determined categories to limit a search to a particular category. Preferably such a selection is made via a mouse and a drop-down style menu. Upon selecting a main category, only the symbols 18 for those providers that have been associated with the particular main category will be shown in the first region 12 of the visual interface 10. If the number of providers associated with the particular main category is larger than the number of symbols 18 that can be displayed in the first region 12 of the visual interface 10 at any one time, the user can utilize the scrollbar 20 to change which symbols 18 are displayed, thereby allowing the user to browse through all the symbols of such providers.

As the user browses through the various symbols 18 for each of the providers of the particular main category selected, he or she may select individual providers of interest, preferably one at a time, to obtain more information about the particular provider. This is preferably done by selecting the symbol 18 associated with the provider using a mouse. Once selected, information associated with the particular provider is displayed in the information display portion 22 of the second region 14 of the visual interface 10. Preferably a particular type of information is associated with each of the display selectors 26 and the user can then select among the various categories of information associated with the particular provider so as to display the particular information sought by the user, without having to display non-pertinent information. This is preferably done using a mouse to select among the plurality of display selectors 26 located in the second region 14 of the visual interface 10. It should be understood that the informational display is preferably large enough to show, for example, a small map showing the location of the provider's business, the address and phone number of the provider, and a brief summary of the goods and services offered by the provider. In some cases, it may be effective to have certain portions of the information displayed adjustable. For example, if a map is shown, it may be advantageous for a user to be able to click on the map to zoom into a particular location of interest. Alternatively the information display portion 22 could grow or shrink and more or less categories of information could be displayed simultaneously as desired.

When selecting and viewing information pertaining to a particular provider, the first region 12 of the visual interface 10 preferably remains unchanged and the user remains able to quickly select other providers. Upon selecting another provider using its respective symbol 18, information pertaining to the newly selected provider preferably replaces the information previously displayed in the information display portion 22 of the second region 14 of the visual interface 10. However, when selecting various providers, the type or category of information displayed preferably remains constant or unchanged unless the user selects a different category using the display selectors 26. This allows the user to rapidly search through various providers and compare the particular type of information. Alternatively, the type or category of information displayed could default to a particular category upon selection of each new provider.

To further aid the user in finding those providers of particular interest, the web site of the preferred embodiment of the invention is preferably provided with a second search mechanism that is activated using the search selector 32 near the bottom of the second region 14 of the visual interface 10. The second search mechanism can be similar to the main category selector and allow the user to select a more limited sub-category of providers. Alternatively, the second search mechanism can be a key-word search mechanism that allows the user to enter words of particular interest. Regardless of the particular mechanism utilized, the second search mechanism then searches through the information associated with each of the providers to identify those providers matching the particular criteria.

Unlike the main category search, the website of the preferred embodiment doesn't eliminate the symbols 18 of those providers that fail to meet the search criteria entered in the second search mechanism, but rather is provided with means for visually distinguishing the symbols 18 of those providers matching the criteria from those that do not. In the preferred embodiment of the invention, the providers matching the criteria of the second search mechanism are indicated by displaying a highlighted border 36 around their respective symbols 18 in the first region 12 of the visual interface 10, without obstructing the graphics contained therein. When so displayed as shown in FIG. 1, the user can search through all of the providers associated with the selected main category and can also visually distinguish those providers matching the second search criteria as well. Thus, symbols 18 for those providers associated with the selected main category remain selectable and the user can still view information pertaining to them even though they do not meet the second search criteria. This reduces the chances of users inadvertently omitting a pertinent provider as a result of entering poor second search criteria. However, if the user finds the above-mentioned feature of the preferred embodiment to be disadvantageous in any particular situation, the web site of the preferred embodiment is provided with a means for displaying symbols 18 for only those providers matching both the main category and the second search criteria. Such feature may prove useful in situations where numerous providers are listed in the main category with only a few matching the second search criteria. It should be understood that the visual indication could be any type of indication known in the art such as simply overlaying a checkmark over the symbol 18 corresponding to each of the relevant providers. At any time when a new search is conducted using the second search mechanism, highlighting for the previous search is preferably removed and reapplied to the symbols 18 of those providers matching the new criteria.

In addition to the features described above, a user can preferably add any of the providers to a “favorites” list. To do this, the user simply selects the “add to favorites” selector 28 in the second region 14 of the visual interface 10 using his or her mouse while information pertaining to the particular provider is being displayed in the information display portion 22 of the second region 14 of the visual interface 10. Once added to the favorites list, the symbol 18 for a provider included in the favorites list is preferably visually distinguish from those not on the list. In the preferred embodiment of the invention, this is preferably done by superimposing red circle 38 over each of the symbols 18 of such providers to distinguish them from the symbols 18 of those providers not included in the favorites list. Alternatively, other methods include, but are not limited to, using highlighting similar to that described above in reference to the second search mechanism with a different color. The visual indication of a particular provider as being included in a favorites list preferably remains visible regardless of any particular search. The user, if desired, can also view only those providers included in the favorites list by selecting the favorites page selector 30 using his or her mouse. Upon so doing, only the symbols 18 for those providers included in the favorites list will be displayed in the first region 12 of the visual interface 10.

Finally, the third region 16 of the visual interface 10 provides space to include sponsor advertisements 34. Like the symbols 18 of the providers, the sponsor advertisements 34 are preferably graphical in nature. The sponsor advertisements 34 may change for each search and may also change after a given time of being displayed. Preferably, the sponsor advertisements 34 remain in their same location as the user scrolls through the symbols 18 of the providers. Unlike sponsor advertisements on prior art websites which are typically links to the website of the given sponsor, the sponsor advertisements 34 of the preferred embodiment of the invention act as a means of visually distinguishing the symbols 18 of various providers affiliated with a particular sponsor, preferably in a manner similar to the highlighting of the second search mechanism. Thus, when a user selects one of the sponsor advertisements 34, the previous second search criteria is preferably deleted and only the symbols 18 of the providers associated with the sponsor advertisement 34 are highlighted.

While the present invention has been described by reference to specific embodiments, it should be understood that modifications and variations of the invention may be constructed without departing from the scope of the invention defined in the following claims.

What is claimed:

1. A method comprising:
obtaining information pertaining to each of a plurality of providers of goods or services;
associating at least some of the obtained information with first and second categories for each of the providers;
providing an Internet website able to access the first and second categories of the information for each of the providers, the website comprising a visual interface with a first region and a second region, the first region being adapted to simultaneously display a symbol for each of at least two of the providers, the second region being adapted to selectively and alternatively display the first and second categories of the information pertaining to each of the providers;
displaying the symbol for each of a portion of the providers simultaneously via the first region of the visual interface of the website; and
displaying a particular one of the first and second categories of the information pertaining to a selected provider via the second region of the visual interface of the website in response to an input signal from a user of the website, the input signal corresponding to selection by the user of the selected provider from among the portion of the providers by selecting the symbol of the selected provider displayed in the first region of the visual interface of the website.

2. The method of claim 1 wherein the website comprises a search engine, the method further comprising using the search engine, upon receipt of a user input associated with a criteria, to search through the information pertaining to the providers to identify a group of the providers that are associated with the criteria, the portion of the plurality of the providers whose symbols are displayed being among the group of the providers.

3. The method of claim 2 wherein each of the providers is associated with at least one of a plurality of consumer groups as part of the information and wherein the criteria is one consumer group selected by the user from among the plurality of the consumer groups.

4. The method of claim 2 wherein the symbols comprise graphical advertisements.

5. The method of claim 2 wherein a location is associated with each of the providers as part of the information and wherein the criteria is representative of a distance between a user entered location and that of the location associated with each of the providers, the group of the providers being those of the providers whose location is no more than the distance from the user entered location.

6. The method of claim 1 wherein the website comprises a search engine, the method further comprising the step of using the search engine, upon receipt of a user input associated with a criteria, to search through the information pertaining to the providers to identify a group of the providers that are associated with the criteria, the step of displaying the symbol for each of a portion of the providers comprising visually distinguishing the symbol of each of the portion of the providers that are among the group of providers from the symbol for each of any of the portion of providers that are not among the group of providers.

7. The method of claim 6 wherein the step of displaying the symbol for each of a portion of the providers comprises selecting between limiting and non-limiting modes, the limiting mode limiting the portion of providers whose symbols are displayed to only those of the providers that are among the group of the providers, the non-limiting mode not limiting the portion of providers whose symbols are displayed to only those of the providers that are among the group of the providers.

8. The method of claim 6 wherein the symbols comprise graphical advertisements.

9. The method of claim 8 wherein the symbol of each of the providers that is among the group of the providers is highlighted to visually distinguish it from each symbol of any of the portion of providers that are not among the group of the providers.

10. The method of claim 6 wherein the search engine constitutes a first search engine, the criteria constitutes a first criteria, and the group constitutes a first group, the website further comprising a second search engine, and the method further comprising:
using the second search engine to search through the information pertaining to the providers to identify a second group of the providers that are associated with a second criteria;
the step of displaying the symbol for each of a portion of the providers comprising limiting the portion of the providers whose symbols are displayed to only those providers also being among the second group of the providers.

11. The method of claim 6 further comprising the step of associating the selected provider with a group of favorite providers in response to a second input signal from the user of the website, and wherein the step of displaying the symbol for each of a portion of the providers comprises visually distinguishing the symbol of each of the portion of the providers that are associated with the group of favorite providers from the symbol for each of any of the portion of providers that are not associated with the group of favorite providers.

12. The method of claim 6 wherein the visual interface of the website comprises a third region, the method further comprising:
associating at least one of the providers with a sponsor symbol;
displaying the sponsor symbol in the third region of the visual interface of the web page; and
visually distinguishing the symbol of each of the portion of the providers that are among the at least one of the providers associated with the sponsor symbol from the symbol for each of any of the portion of providers that are not among the at least one of the providers associated with the sponsor symbol in response to a second input signal, the second input signal corresponding to selection by the user of the sponsor symbol displayed in the third region of the visual interface of the web page.

13. The method of claim 6 wherein a location is associated with each of the providers as part of the information and wherein the criteria is representative of a distance between a user entered location and that of the location associated with each of the providers, the group of the providers being those of the providers whose location is no more than the distance from the user entered location.

14. The method of claim 1 further comprising storing the first and second categories of the information for each of the providers solely within the website such that the step of displaying the particular one of the categories is performed without the website accessing a database external to the website.

15. The method of claim 14 wherein the symbols comprise graphical advertisements.

16. The method of claim 1 further comprising the step of associating the selected provider with a group of favorite providers in response to a second input signal from the user of the website.

17. The method of claim 16 wherein the step of displaying the symbol for each of a portion of the providers comprises visually distinguishing the symbol of each of the portion of the providers that are associated with the group of favorite providers from the symbol for each of any of the portion of providers that are not associated with the group of favorite providers.

18. The method of claim 17 wherein the symbol of each of the providers that is associated with the group of favorite providers is superimposed with a colored circle to visually distinguish it from each symbol of any of the portion of providers that are not associated with the group of favorite providers.

19. The method of claim 16 wherein the step of displaying the symbol for each of a portion of the providers comprises selecting between limiting and non-limiting modes, the limiting mode limiting the portion of providers whose symbols are displayed to only those of the providers that are associated with the group of favorite providers, the non-limiting mode not limiting the portion of providers whose symbols are displayed to only those of the providers that are associated with the group of favorite providers.

20. The method of claim 1 wherein the visual interface of the website comprises a third region, the method further comprising:
associating at least one of the providers with a sponsor symbol;
displaying the sponsor symbol in the third region of the visual interface of the web page; and
visually distinguishing the symbol of each of the portion of the providers that are among the at least one of the providers associated with the sponsor symbol from the symbol for each of any of the portion of providers that are not among the at least one of the providers associated with the sponsor symbol in response to a second input signal, the second input signal corresponding to selection by the user of the sponsor symbol displayed in the third region of the visual interface of the web page.
